(19) United States
(12) Patent Application Publication
(10) Pub. No.: US 2025/0237498 A1
(43) Pub. Date: Jul. 24, 2025

(54) OPTICAL SPATIAL PROBE

(71) Applicant: Optical Metrology Solutions LLC, Niskayuna, NY (US)

(72) Inventors: Kevin G. Harding, Niskayuna, NY (US); Robert W. Tait, Niskayuna, NY (US); Craig A. Cantello, Amsterdam, NY (US)

(21) Appl. No.: 18/420,545

(22) Filed: Jan. 23, 2024

(51) Int. Cl. G01B 11/25

(52) U.S. Cl. CPC G01B 11/254

(57) ABSTRACT

An optical spatial probe comprising a light source for shining a beam of light on an object and collection optics for collecting light reflected from the surface. The collected light is collimated, and the collimated light beam passed through gratings that impart patterns to the collimated beam. The collimated beam may be split into multiple beam subdivisions. A camera captures the patterns, or a plurality of photodetectors detect light intensities of the patterns to determine distance to the object.

### TECHNICAL FIELD

The present invention relates to an improved optical probe for measuring spatial relation (“optical spatial probe”) of an object such as distance, angle and shape.

### BACKGROUND OF THE INVENTION

With reference to FIG. 1 (prior art), in an optical spatial probe applying basic laser triangulation gage measurement techniques, a laser spot is projected onto the surface of the object to be measured, and that spot is viewed by a detector from a different angle. Displacement of the test surface causes the image to move across the detector surface. That movement may be directly measured, and displacement of the test surface may be determined from that measurement according to the known geometric relationship between the two.

Laser triangulation gages are used in many industries including, for example, manufacturing of sheet metal, power generation components and large vehicle parts. To obtain the micron level resolution demanded by new manufacturing tolerances, laser triangulation gages today have a working range of only a few millimeters.

The working range is the range of distances over which the gage can measure distance within a desired measurement resolution. For example, a gage may have a working range of 300 mm at a desired resolution of 10 μm. If that gage is positioned 3 meters away from the object, the gage can measure distances with a 10 μm resolution over the range of 3 m+150 mm. High “range to resolution” ratios are desirable.

Achievable range to resolution in current laser triangulation gages is limited by the nature of the detection used in these gages. The position of the spot on the detector is determined by the centroid of the total light detected on a single detector or detector array. With reference to FIG. 2, the image of the laser spot seen on the detector can be very irregular in shape and distribution due to laser speckle, to effects of surface texture, and to coherent interference collected by the viewing lens. The centroid of the total light detected can vary significantly due to changes in the light distribution in the spot. Plotting the distance to a spot as it moves across a flat ground surface would theoretically produce a smooth line, but the effects of surface texture and laser speckle can cause irregular jumps in the centroid location as the spot moves across the object surface, which causes irregular jumps in the detected location, which introduces measurement error.

Small bright reflections, specular reflections, and surface transition points such as edges will all change the distribution of the light in the surface spot image, which in turn will change the centroid location and the measured range.

Another limitation of current gages is that only a small area of the detector is used for the measurement. That is, the image of the surface spot may cover, for example, an area on the detector of 20 by 20 pixels or 400 pixels all together out of several million pixels on the detector. The width of the detector is needed to cover the range of motion of the spot which determines the range of measurements. This limits the number of sample points that can be used to locate the spot centroid which allows a small anomaly such as a piece of dust or electrical noise of the detector to have a large influence on the measurement.

There is a need for an optical spatial probe that overcomes these limitations. The present invention fulfills this need by providing a device comprising an optical collimator that collimates the light field reflected from the test surface, a grating that imposes a pattern in the collimated light field that may cover the full detector array, and a detector that detects the amount of shift of the pattern to determine the distance to the object.

### SUMMARY OF THE INVENTION

In a first aspect, the present invention provides an optical device for measuring spatial relation, comprising: a light source for projecting a beam of light along a first axis onto a surface of an object; an optical collimator disposed a radial distance from the axis for collimating at least some of the light reflected off the surface and directing the collimated light along a path; a grating disposed in the path for imparting a pattern in the collimated light; and a camera for capturing an image of the pattern.

In a second aspect, the present invention provides an optical device for measuring spatial relation, comprising: a light source for projecting a beam of light along a first axis onto a surface of an object; an optical collimator disposed a radial distance from the axis for collimating at least some of the light reflected off the surface and directing the collimated light along a path; a first grating disposed in the path for imparting a pattern in the collimated light; and a photodetector disposed in the path for receiving the pattern.

In a third aspect, the present invention provides an optical device for measuring spatial relation, comprising: a light source for projecting beam of light along a first axis onto a surface of an object; a plurality of photodetectors comprising a first photodetector and a second photodetector; an optical collimator disposed a radial distance from the axis for collimating at least some of the light reflected off the surface and directing the collimated light along a first path; a beam splitter disposed in the first path for dividing the beam of collimated light into a plurality of beam subdivisions and directing the beam subdivisions along separate subpaths; said plurality of beam subdivisions comprising a first beam subdivision directed along a first subpath towards the first photodetector and a second beam subdivision directed along a second subpath toward the second photodetector; a master grating disposed in the first path between the collimator and the beam splitter; a first submaster grating disposed in the first subpath between the beam splitter and the first photodetector; and a second submaster grating disposed in the second subpath between the beam splitter and the second photodetector.

In a fourth aspect, the present invention provides an optical device for measuring spatial relation of a mirror, comprising: a collimated light for projecting a beam of collimated light along a master path toward a mirror; a first beam splitter disposed in the master path for dividing the beam of collimated light reflected by the mirror into subdivisions comprising a first beam subdivision and directing the first beam subdivision along a first subpath; a second beam splitter disposed in the first subpath for dividing the first beam subdivision into a second and third beam subdivision and directing the second beam subdivision along a second subpath and third beam subdivision along a third subpath; a grating disposed in the second subpath for imparting a pattern in the collimated light; a first camara disposed in the second subpath for capturing an image of the pattern; a lens disposed in the third subpath for focusing the third beam subdivision into a focused third beam subdivision; and a second camara disposed in the third subpath for capturing an image of the focused third beam subdivision.

In a fifth aspect, the present invention provides a method for measuring spatial relation of an object, comprising: project a beam of light from a light source along a first axis onto a surface of an object that is a first distance away from the light source; dispose an optical collimator a radial distance from the axis for collimating at least some of the light reflected off the surface and directing the collimated light along a path; collimate at least some of the light reflected from the surface; direct the collimated light along a path; dispose a camera in the path; dispose a grating in the path between the collimator and the camera, said grating comprising a grating pattern for imparting a light pattern in the collimated light; impart a light pattern in the collimated light corresponding to the grating pattern; capture an image comprising at least some of the light pattern with the camera, said image within a planar frame; define a target location in the planar frame corresponding to a baseline distance to the object; measure a planar distance in the planar frame from the location of the captured light pattern to the target location; and apply triangulation mathematics to the value of the planar distance to determine the difference between the baseline distance and the first distance to the object.

In a sixth aspect, the present invention provides a method for measuring spatial relation of an object, comprising: project a beam of light from a light source along a first axis onto a surface of an object that is a first distance away from the light source; dispose an optical collimator a radial distance from the axis; collimate at least some of the light reflected from the surface; direct the collimated light along a path from the collimator toward a beam splitter; dispose a master grating in the path between the collimator and the beam splitter, said master grating comprising a grating pattern for imparting a master light pattern in the collimated light; impart a master light pattern in the collimated light corresponding to the master grating pattern; dispose the beam splitter in the path; divide the beam of collimated light into a plurality of beam subdivisions comprising a first beam subdivision, a second beam subdivision and third beam subdivision; direct the first beam subdivisions along first subpath, direct the second beam subdivision along a second subpath, and direct the third beam subdivision along a third subpath; dispose a first photodetector in the first subpath, a second photodetector in the second subpath, and a third photodetector in the third subpath; dispose a first submaster grating in the first subpath between the beam splitter and the first photodetector, a second submaster grating in the second subpath between the beam splitter and the second photodetector and a third submaster grating in the third subpath between the beam splitter and the third photodetector, with each of the submaster gratings phase-shifted relative to the other submaster gratings by know amounts; measure a first intensity of light received by the first photodetector; measure a second intensity of light received by the second photodetector; measure a third intensity of light received by the third photodetector; and determine the distance to the object based on the relative values of the first intensity, second intensity and third intensity.

In a seventh aspect, the present invention provides a method for measuring special relation of a mirror, comprising: project a beam of collimated light along a master path toward a mirror; divide the beam of collimated light reflected by the mirror into subdivisions comprising a first beam subdivision and direct the first beam subdivision along a first subpath; divide the first beam subdivision into a second and third beam subdivision and direct the second beam subdivision along a second subpath and third beam subdivision along a third subpath; impart a pattern in the second beam subdivision; capture a first image of the pattern with a first camera; compare the position of the first image with a predetermined position corresponding to a known mirror angle to determine the amount of pattern shift; focus the third beam subdivision into a focused third beam subdivision; and capture an image of the focused third beam subdivision with a second camera for obtaining a coarse angle measurement.

### BRIEF DESCRIPTION OF THE DRAWINGS

The subject matter that is regarded as the invention is particularly pointed out and distinctly claimed in the concluding portion of the specification. The invention, however, may be best understood by reference to the following detailed description of various embodiments and the accompanying drawings and photographs in which:

FIG. 1 is a schematic side view representation of the basic principle of laser triangulation gage measurement;

FIG. 2 is a plan view of the irregular light patterns of the laser spot viewed on the surface of the object of FIG. 1;

FIG. 3 is a schematic side view representation of one embodiment of the improved laser triangulation gage type of optical spatial probe of the present invention;

FIG. 4 is a schematic side view representation of another embodiment of the improved laser triangulation gage type of optical spatial probe of the present invention;

FIG. 5 is a schematic side view representation of collimated laser light passing through successive gratings of the present invention at two different points in time, one represented by solid rays and the other represented by dashed rays;

FIG. 6 is a representation of a sequence of four snapshots of a shifting beat pattern projected onto a photodetector taken during a measurement sequence, each snapshot corresponding to a different measurement distances; and

FIG. 7 is a schematic side view representation of an alternate embodiment of the present invention for measuring mirror angles.

FIGS. 8-12 are schematic representations of alternate embodiments of gratings of the present invention.

### DETAILED DESCRIPTION OF THE INVENTION

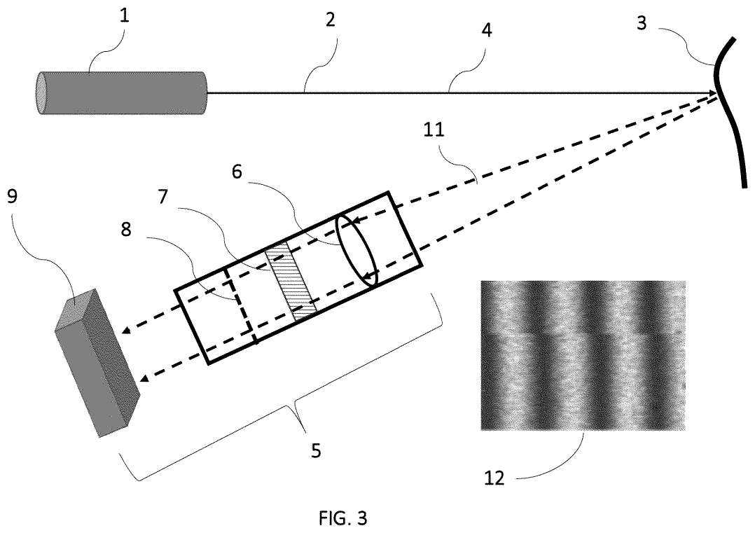

With reference to FIG. 3, one embodiment of an optical spatial probe of the present invention is shown. Laser light source 1 is pointed along a first axis 2 towards a surface 3 of an object and emits a laser beam 4 onto a spot on surface 3. Collection optic 5, comprising lens 6, color filter 7, grating 8 and first camera 9, is pointed along a second axis at an angle from the first axis and collects return light 11 emanating from the spot. Collection optic is “off axis” in reference to the laser beam axis. The collected light passes through lens 6, then through color filter 7, then through grating 8 and finally into first camera 9.

The effects of small bright reflections, surface transition points and specular reflections from the surface location may be minimized by relaying the reflected light to infinity by the process known as “collimating” the reflected light. The collimated image of the surface is very far away and the surface structure information in the image is averaged over the full light field seen, producing a uniform field of light. Lens 6 collimates the collected light.

With further reference to FIG. 3, Color filter 7 filters the collimated light and passes the desired colors through. Grating 8 comprises a grating pattern, which imparts a corresponding pattern in the collimated light. First camera 9 captures pattern 12, which is a sine wave pattern.

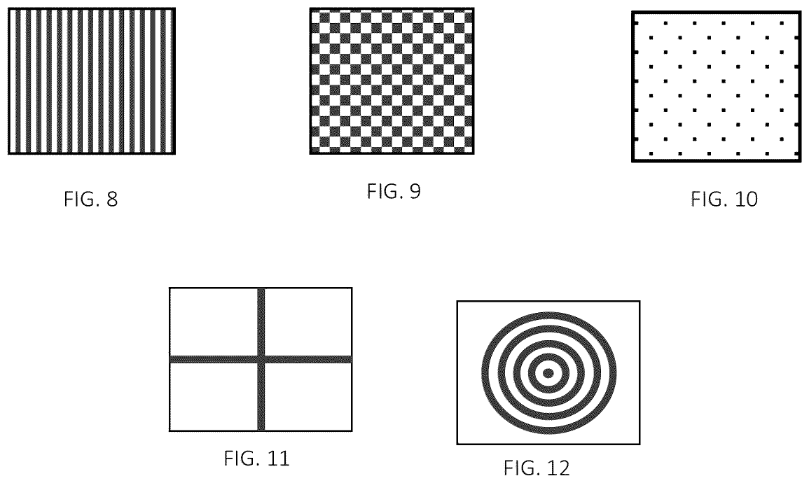

Gratings may comprise anything that can be inserted into the path of light and impart a light pattern of varying light intensity in the light. The light pattern may be cast onto and received by a lens, photodiode, photo detector or any other object. A grating may comprise a pattern on or in a substrate comprising a thin sheet of transparent glass or plastic film, such as slide or transparency. With reference to FIGS. 3 and 8-12, preferably the pattern comprises a repeating pattern, such as one representing a sinusoidal or other periodic function (such as the sine wave pattern 12 in FIG. 3), a series of parallel lines (FIG. 8), an orthogonal grid pattern (FIG. 9), or a dot pattern (FIG. 10). The pattern may comprise a cross hair pattern (FIG. 11), bull's eye pattern (FIG. 12), or any other pattern. The pattern may comprise an image, such as a photographic negative.

With further reference to FIG. 3, in pattern 12 the intensity of light has a repeating sinusoidal pattern. Analysis tools are available to measure both period and phase position of sine wave patterns. A change in distance from the laser light source to the object's surface causes a shift of the pattern, which can be analyzed as a phase shift of a sine wave. The amount of shift may be directly measured, and displacement of the test surface may be determined from that measurement according to the known geometric relationship between the two.

The camera captures the light pattern image within a planar frame. A target or reference location may be defined in the planar frame corresponding to a known, calibrated baseline distance to the object. The distance between the captured image and target location in the planar frame may be measured. Triangulation mathematics is then applied to the value of the planar distance to determine the difference (or “delta”) between the baseline distance and the distance to the object. The actual distance is the sum of the baseline distance and the delta.

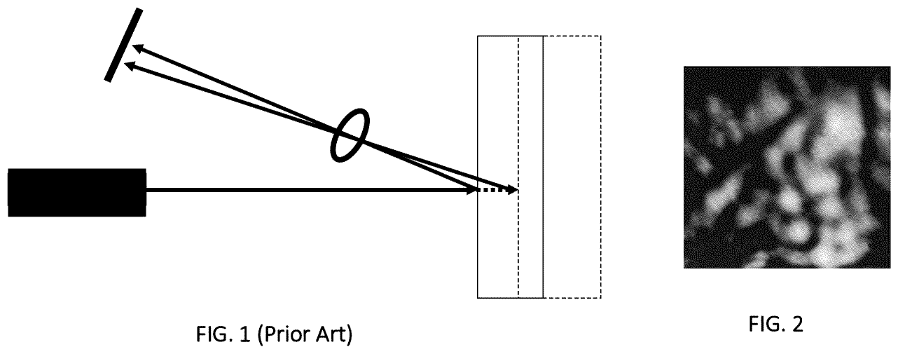

With further reference to FIG. 3, a beam splitter (not shown) may be disposed between grating 8 and camera 9 to divide the beam and direct one beam subdivision along a subpath to a lens (not shown) that focuses the beam subdivision toward a second camera (not shown) for obtaining a coarse distance measurement in the usual way of tracking the centroid of a reflected spot of light described above with reference to prior art FIG. 1. Said coarse distance measurement is of sufficient resolution to track the number of cycles or periods of the repeating pattern that the pattern captured by first camera 9 may have shifted. The phase shift of the pattern captured by first camera 9 provides finer measurement resolution within a cycle or period.

The pattern itself may be larger than the detector as long as a means for tracking the full pattern is employed such as a secondary coarse position sensing detector or by using the effect that over a long range the collimated beam will become more or less focusing. The focusing effect will change the period of an imposed sine wave or the size of whatever pattern is used. The size change effect is small, but sufficient to keep track of, for example, which part of the sine wave is being viewed. This feature of tracking beyond the movement of a spot confined by the detector area allows this invention to have a longer measurement range than current triangulation sensors.

With reference to FIG. 4, in another embodiment of an improved laser triangulation optical spatial probe of the present invention, Laser light source 14 emits a laser beam 15 along an axis 16 onto a spot on the surface of an object (not shown). From a position off axis, collection optic 17 collects return light 18 from the laser spot. A collimating curved mirror 19 reflects a collimated beam of light 20 through a master grating 21. Master grating 21 imparts a pattern in the beam corresponding to the shape of the grating. The patterned beam projects forward on path segment 22 into beam splitter 23 which splits the beam into five separate beam subdivisions along five different pathways (or “subpaths”). Each beam subdivision may have the same size, shape and pattern as the beam on path segment 22. One beam subdivision passes through lens 35 onto a lateral effect photodiode 30 for obtaining a coarse distance measurement in the usual way of tracking the centroid of a reflected spot of light described above with reference to prior art FIG. 1. The other four beam subdivisions pass through respective submaster gratings 26, 27, 28 and 29, which are disposed in front of respective photodetector 31, 32, 33 and 34.

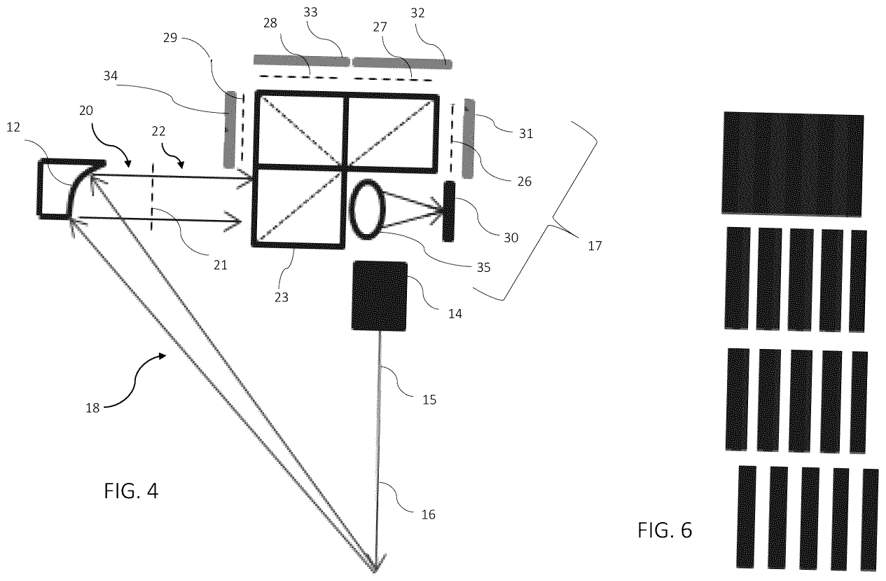

With reference to FIG. 5, master grating 21 and a submaster grating 26 of FIG. 4 cooperate to change the intensity of light hitting photo detector 31 of FIG. 4. The collimated beam of light 20 passes through master grating 21 and beam subdivision 40 (beam splitter not shown) passes through a submaster grating 26 to cast a beat pattern on the photodetector. In a preferred embodiment, the master grating comprises opaque, spaced-apart parallel strips arranged on a plane transverse to the collimated beam. Each submaster grating comprises opaque, spaced-apart parallel strips arranged on a plane transverse to the collimated beam subdivision, with the strips arranged parallel to the strips of the master grating. With further reference to FIG. 5, the solid rays illustrate a collimated beam and beam subdivision projecting at a first angle, and the dashed rays illustrate the same collimated beam at a different moment in time projecting at a second angle. At the second angle, less light passes through the submaster grating. The angle of the collimated beam and beam subdivision are a function of distance between the light source and the object being measured. Therefore, since the amount of light passing through submaster grating 26 is a function of said distance, the resulting intensity of light received by photodetector 31 is a function of distance.

With further reference to FIGS. 5 and 6, FIG. 6 represents the progression of a beat pattern projected onto a photodetector at four increments of time during a measurement sequence, producing four different angles corresponding to four different distances to the object. The different stages of progression are shown in sequence for illustration purposes only. On one extreme, the grating patterns are most aligned and the most light passes through to the photodetector. As the distance and angle changes, less light passes through, and the entire image shifts.

With further reference to FIGS. 4, 5 and 6, submaster gratings 26, 27, 28 and 29 are shifted relative to each other, thus each is positioned differently relative to the master grating. In this embodiment having four submaster gratings, each submaster grating may be shifted by a 90° expressed in angles where 360° represents one cycle (or “period”) of a repeating pattern so that the gratings are at 0°, 90°, 180° and 270°. Therefore, for a given surface spot distance, the shadow cast by the submaster gratings on the photodetectors will be shifted in 90° increments (or 1/4 phase increments) resulting in correspondingly different overlap with the shadow cast by the master grating. Movement of the spot on the object surface will cause the angle of the collimated beam and four beam subdivisions to change by the same amount, resulting in changes of light intensity reaching each photodetector. The relative intensities detected by the four photodetectors at any given distance establishes the phase. The change in relative intensities caused by movement of the spot establishes the phase-shift of the images. Triangulation mathematics is then applied to the value of the phase shift to determine the change of distance to the object.

The angle of the spot relative to the collection optical axis is thus measured using a phase shift. Each path uses a 120 or 90-degree shift (for 3 or 4 step phase shift) of the submaster grating to create an effective phase shift style signal. Each detector path sees a different total intensity due to the shift of the second grating relative to the shadow of the master grating, which effectively measures the change in overlap of the grating pattern per the angle of the spot relative to the collection optic, and thereby the distance. An additional detector without a submaster grating may comprise a lateral effect photodiode to obtain a coarse distance measurement in the usual way of tracking the centroid of a reflected spot of light described above with reference to prior art FIG. 1.

By collimating the light from the test surface, then imposing a pattern in the collimated light, and measuring pattern shifts to determine the distance to the test surface spot, the present invention provides an improved triangulation optical range sensor that is agnostic to surface texture effects such as specular or diffuse reflections. Collimating the light from the surface spot minimizes the effects of surface texture by imaging the test surface light spot to infinity. The infinite image permits measurement using both diffuse and specular reflections continuously. Accuracy of the measurement is improved by using the full sensing field of the photodetector for the measurement rather than just a small spot on the field. Measurement range is improved by using a second measurement based upon magnification to allow a pattern to move beyond the boundaries of the sensing detector.

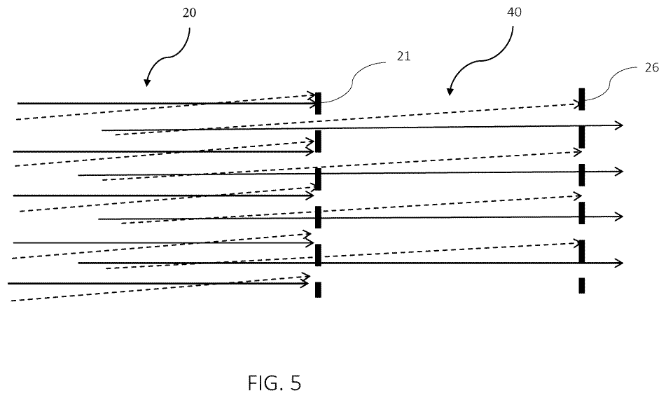

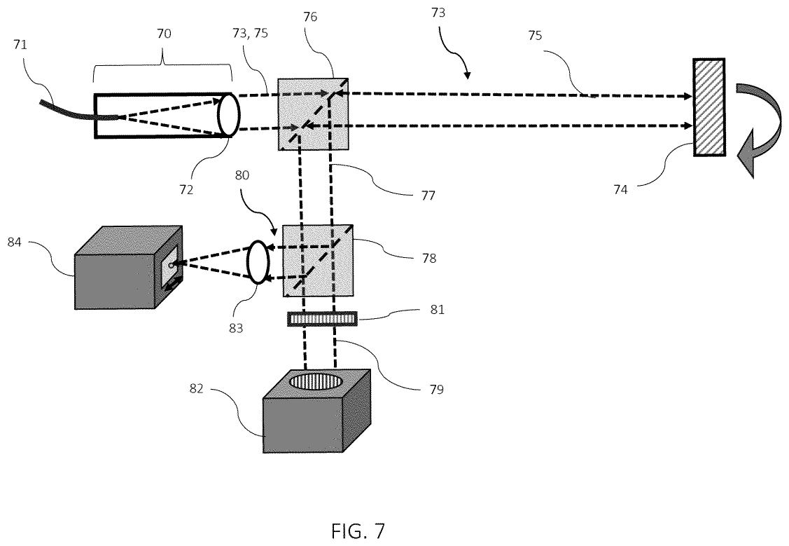

With reference to FIG. 7, an alternate embodiment of the present is adapted for measuring the angle of a mirror, defined here as a mirror or other surface that produces mirror-like specular reflection. Collimating light 70 comprises a light source 71 and collimating lens 72. Light 70 emits a collimated light beam 73 along a master path 75 aimed at a mirror 74. A first beam splitter 76 is disposed in the master path between light 70 and mirror 74, which passes some of beam 73 through along master path 75 to the mirror. Collimated light reflects off the mirror back to the first beam splitter along master path 75. The return leg of master path 75 (reflected off the mirror) will be at an angle to the outbound leg (from collimating light 70) if the mirror is at an angle not perpendicular to the outbound leg. The reflected collimated light is divided by the first beam splitter 76 into subdivisions comprising a first beam subdivision 77 directed to a second beam splitter 78. First beam subdivision 77 is divided into a second beam subdivision 79 and third beam subdivision 80. Second beam subdivision 79 passes through grating 81 onto a first camara 82. Grating 81 imparts a pattern in the collimated light, which pattern is captured by first camera 82. A change in angle of the mirror causes a change in the angle of the reflected light, which causes a shift of the pattern captured by first camera 82. The pattern may have a repeating sinusoidal pattern and pattern shifts may be analyzed as a phase shift of a sine wave. Analysis tools are available to measure both period and phase position of sine wave patterns. The amount of shift may be directly measured, and angular displacement of the mirror may be determined from that measurement according to the known geometric relationship between the two.

With further reference to FIG. 7, third beam subdivision 80 is directed to a second lens 83, which focuses the beam to a spot on second camera 84. Changes in the angle of the mirror will shift the location of spot on the second camera. Movement of the spot provides coarse measurement of the angle change. If the repeating pattern captured by first camara 82 shifts by more than one period, the coarse measurement would determine how many periods of shift may have occurred. For example, if a sinusoidal pattern shifts by an entire period plus 1/4 phase, it might be interpreted as only a ¼ phase shift, but the coarse measurement tells the operator that the shift exceeds one period.

Phase shift of a pattern detected by the first camera measures angular displacement of mirror 74 about one axis. The coarse measurement also will detect whether there is angular displacement about another axis.

If the mirror is curved the period of the sine wave pattern captured by first camera 82 may change, and the amount of change of the period may be measured. The curvature of the mirror can be calculated if that measurement and the measurement of movement of the spot captured by second camera 84 are both known. The coarse measurement also will detect if there is any change in focus of the spot on the second camera due to curvature of the mirror, which will change the size of the spot image captured by second camera 84.

While the invention has been particularly shown and described with reference to certain embodiments, it will be understood by those skilled in the art that various changes in form and details may be made to the invention without departing from the spirit and scope of the invention as described in the following claims.

We claim:

1. An optical device for measuring spatial relation of an object, comprising:
a light source for projecting a beam of light along a first axis onto a surface of an object;
a collimator disposed a radial distance from the axis for collimating at least some of the light reflected off the surface and directing the collimated light along a path;
a grating disposed in the path for imparting a pattern in the collimated light;
a camera for capturing an image of the pattern.

2. The optical device of claim 1, further comprising:
said grating comprising a sine wave pattern.

3. The optical device of claim 1, further comprising:
said collimator comprising a lens.

4. The optical device of claim 1, further comprising:
said collimator comprising a mirror.

5. An optical device for measuring spatial relation of an object, comprising:
a light source for projecting a beam of light along a first axis onto a surface of an object;
a collimator disposed a radial distance from the axis for collimating at least some of the light reflected off the surface and directing the collimated light along a path;
a first grating disposed in the path for imparting a pattern in the collimated light;
a photodetector disposed in the path for receiving the pattern.

6. The optical device of claim 5, further comprising:
a second grating disposed in the path a distance from the first grating between the first grating and the photodetector.

7. The optical device of claim 6, further comprising:
said first grating comprising a first pattern and said second grating comprising a second pattern having the same configuration as the first pattern.

8. An optical device for measuring spatial relation of an object, comprising:
a light source for projecting beam of light along a first axis onto a surface of an object;
a plurality of photodetectors comprising a first photodetector and a second photodetector;
a collimator disposed a radial distance from the axis for collimating at least some of the light reflected off the surface and directing the collimated light along a first path;
a beam splitter disposed in the first path for dividing the beam of collimated light into a plurality of beam subdivisions and directing the beam subdivisions along separate subpaths;
said plurality of beam subdivisions comprising a first beam subdivision directed along a first subpath towards the first photodetector and a second beam subdivision directed along a second subpath toward the second photodetector;
a master grating disposed in the first path between the collimator and the beam splitter;
a first submaster grating disposed in the first subpath between the beam splitter and the first photodetector; and
a second submaster grating disposed in the second subpath between the beam splitter and the second photodetector.

9. The optical device of claim 8, further comprising:
a third photodetector;
a third beam subdivision directed along a third subpath toward the third photodetector; and
a third submaster grating disposed in the third subpath between the beam splitter and the third photodetector.

10. The optical device of claim 9, further comprising:
a fourth photodetector;
a fourth beam subdivision directed along a fourth subpath toward the fourth photodetector; and
a fourth submaster grating disposed in the fourth subpath between the beam splitter and the fourth photodetector.

11. The optical device of claim 9, further comprising:
a lateral effect photodiode;
a fifth beam subdivision directed along a fifth subpath toward the lateral effect photodiode for obtaining a coarse distance measurement.

12. The optical device of claim 10, further comprising:
a lateral effect photodiode;
a fifth beam subdivision directed along a fifth subpath toward the lateral effect photodiode for obtaining a coarse distance measurement.

13. An optical device for measuring special relation of a mirror, comprising:
a collimating light for projecting a beam of collimated light along a master path toward a mirror;
a first beam splitter disposed in the master path for dividing the beam of collimated light reflected from the mirror into subdivisions comprising a first beam subdivision and directing the first beam subdivision along a first subpath;
a second beam splitter disposed in the first subpath for dividing the first beam subdivision into a second and third beam subdivision and directing the second beam subdivision along a second subpath and third beam subdivision along a third subpath;
a grating disposed in the second subpath for imparting a pattern in the collimated light;
a first camara disposed in the second subpath for capturing an image of the pattern;
a lens disposed in the third subpath for focusing the third beam subdivision; and
a second camara disposed in the third subpath for capturing an image of the focused third beam subdivision.

14. A method for measuring spatial relation of an object, comprising:
project a beam of light from a light source along a first axis onto a surface of an object that is a first distance away from the light source;
dispose a collimator a radial distance from the axis for collimating at least some of the light reflected off the surface and directing the collimated light along a path;
collimate at least some of the light reflected from the surface;
direct the collimated light along a path;
dispose a camera in the path;
dispose a grating in the path between the collimator and the camera, said grating comprising a grating pattern for imparting a light pattern in the collimated light;
impart a light pattern in the collimated light corresponding to the grating pattern;
capture an image comprising at least some of the light pattern with the camera, said image within a planar frame;
define a target location in the planar frame corresponding to a baseline distance to the object;
measure a planar distance in the planar frame from the location of the captured light pattern to the target location; and
apply triangulation mathematics to the value of the planar distance to determine the difference between the baseline distance and the first distance to the object.

15. The method of claim 13, further comprising:
said grating pattern comprising a sine wave pattern.

16. A method for measuring spatial relation of an object, comprising:
project a beam of light from a light source along a first axis onto a surface of an object that is a first distance away from the light source;
dispose a collimator a radial distance from the axis;
collimate at least some of the light reflected from the surface;
direct the collimated light along a path from the collimator toward a beam splitter;
dispose a master grating in the path between the collimator and the beam splitter, said master grating comprising a grating pattern for imparting a master light pattern in the collimated light;
impart a master light pattern in the collimated light corresponding to the master grating pattern;
dispose the beam splitter in the path;
divide the beam of collimated light into a plurality of beam subdivisions comprising a first beam subdivision, a second beam subdivision and third beam subdivision;
direct the first beam subdivisions along first subpath, direct the second beam subdivision along a second subpath, and direct the third beam subdivision along a third subpath;
dispose a first photodetector in the first subpath, a second photodetector in the second subpath, and a third photodetector in the third subpath;
dispose a first submaster grating in the first subpath between the beam splitter and the first photodetector, a second submaster grating in the second subpath between the beam splitter and the second photodetector and a third submaster grating in the third subpath between the beam splitter and the third photodetector, with each of the submaster gratings phase-shifted relative to the other submaster gratings by know amounts;
measure a first intensity of light received by the first photodetector;
measure a second intensity of light received by the second photodetector;
measure a third intensity of light received by the third photodetector; and
determine the distance to the object based on the relative values of the first intensity, second intensity and third intensity.

17. A method for measuring spatial relation of a mirror, comprising:
project a beam of collimated light along a master path toward a mirror;
divide the beam of collimated light into subdivisions comprising a first beam subdivision and direct the first beam subdivision along a first subpath;
divide the first beam subdivision into a second and third beam subdivision and direct the second beam subdivision along a second subpath and third beam subdivision along a third subpath;
impart a pattern in the second beam subdivision;
capture a first image of the pattern with a first camera;
compare the position of the first image with a predetermined position corresponding to a known mirror angle to determine the amount of pattern shift;
focus the third beam subdivision into a focused third beam subdivision; and
capture an image of the focused third beam subdivision with a second camera for obtaining a coarse angle measurement.
